(19) United States
(12) Patent Application Publication
(10) Pub. No.: US 2003/0115140 A1
(43) Pub. Date: Jun. 19, 2003

(54) Payment method for on-line purchases

(76) Inventor: Dharam Pal, Singapore (SG)

Correspondence Address: WILDMAN, HARROLD, ALLEN & DIXON, 225 WEST WACKER DRIVE, CHICAGO, IL, 60606, US

(21) Appl. No.: 10/289,538

(22) Filed: Nov. 6, 2002

(30) Foreign Application Priority Data
Nov. 13, 2001 (SG) 200107101-8

(51) Int. Cl. G06F 17/60

(52) U.S. Cl. 705/40

(57) ABSTRACT

A payment scheme for online purchases which includes as participants vendors, a scheme administrator, member organizations and purchasers. Participating purchasers are subscribers to a member organization. Vendors charge the scheme administrator for the value of all purchases made by subscribing purchasers and the scheme administrator charges the member organizations to which purchasers subscribe for their purchases. Member organizations are free to make their own arrangements with their subscribing purchasers to recover money or moneys worth in exchange for the payments they make on behalf of subscribers to the scheme administrator.

### FIELD OF INVENTION

The present invention relates to a payment method for on-line purchases and particularly but not solely a payment system for purchase of goods over the Internet by consumers. The scheme is particularly suitable for low-value transactions (micropayments).

### BACKGROUND OF THE INVENTION

Growth of E-commerce and Internet shopping is constrained by concerns of both merchants and purchasers over the payment mechanisms conventionally used. Existing methods requiring payment by way of conventional means, such as cash, cheque, or credit card, etc, prior to the order being fulfilled with credit cards, details sent over the Internet. While this is convenient, there are problems with fraud and security both on and offline. These problems apply to a certain extent, to other online payment schemes, such as cash cards, e-wallets, electronic cash, etc. Purchasers are concerned about providing their details over the Internet, both for security reasons and for reasons of confidentiality. Additionally, sellers are concerned about fraud and non-payment of purchases.

Much effort is going into improving online payment security but, for various reasons, an acceptable foolproof solution for such payments has not yet been put into practice. Thus there is no convenient online payment method that eliminates the risk element and gives the shopper the comfort of safer online shopping.

Current solutions attempt to provide more secure payment systems in very complex ways. More often they involve a bank or credit card company or other financial institution. The focus is on banks, credit card companies and the existing financial infrastructure in general, as well as technology. Creation of a single e-payment platform, integrating a number of major financial institutions is some way off. In addition, for low payment transactions (micro payments), debit and credit card processing costs are too high. The same is true for cash cards. They also need to be topped up before the actual date of purchase, which is an inefficient use of money.

### SUMMARY OF THE INVENTION

It is an object of the present invention to provide a payment method for on-line purchases which alleviates, at least partially, at least some of the above mentioned problems.

Accordingly in one aspect the present invention consists in a payment scheme for online purchases which includes as participants vendors, a scheme administrator, member organisations and purchasers, characterised in that:

participating purchasers are subscribers to a member organisation,

vendors charge the scheme administrator for the value of all purchases made by subscribing purchasers,

the scheme administrator charges the member organisations to which purchasers subscribe for their purchases,

and member organisations have in place their own arrangements with their subscribing purchasers to recover money or moneys worth in exchange for the payments they make on behalf of subscribers to the scheme administrator.

One application of the invention might be a transaction payment scheme involving employees (as purchasers), employers (as member organisations), merchants and a scheme administrator. Merchants and employers join the scheme, whereby the employers will pay for any online purchases made by employees from those merchants. The scheme is limited to low volume purchases so the employers' exposure is limited to a fixed amount per employee. The merchant is paid by the administrator for all purchases made under the scheme. The administrator is paid by the employers for all purchases made by employees of that employer within, say, the preceding month. The relationship between purchaser and member is such that the credit worthiness of the purchaser is not an issue, thereby allowing non-credit worthy persons to make online purchases. Neither the administrator or the merchant need to know personal details of the purchaser. The member does not need to know the nature of purchases made and only needs to know purchase values. The scheme therefore provides confidentiality for purchasers.

### BRIEF DESCRIPTION OF THE DRAWING

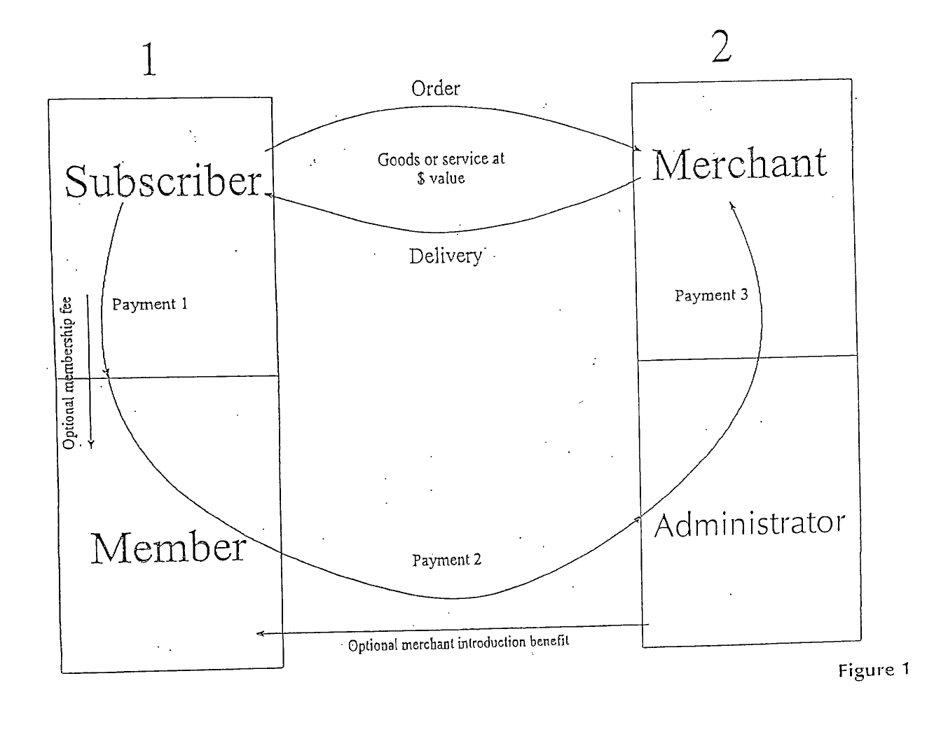

Preferred embodiments of the invention will now be described with reference to the accompanying drawing, in which FIG. 1 is a flowchart showing the parties to the scheme and the payments which pass between them.

### DESCRIPTION OF THE PREFERRED EMBODIMENTS

The present invention is an online scheme or system involving various categories of parties whom have joined up to the scheme: members, subscribers and vendors (merchants). Integral to the scheme is an administrator who controls and runs it.

The main parties are the merchants and members. These are the parties who join the scheme through the administrator. The merchants sell products or services and are paid by the administrator. The members pay the administrator. However, the members do not themselves make purchases. Instead they pay for purchases made by subscribers affiliated with each member.

Members can be any category of organisation. For example employers, educational institutions, clubs or associations or any other group of individuals or even organisations. However, an individual could conceivably be a member. Moreover, members do not need to exist for any other reason; they could come into existence solely for the purpose of being members of the scheme. Members do not need and would be unlikely to be financial institutions such as banks or credit card companies. They are likely to be employers prepared to use their accounting departments creatively.

The subscribers would usually be individuals but could be organisations of some sort. They are subscribers to a member. As such, they are only party to the scheme through the member, and not in their own right. Subscribers might be university students, club members, employees, etc. As such, when the university, club, employer, etc, joins the scheme, these people can subscribe through the university, club, employer, etc.

A subscriber can be associated with more than one different member at the same time. A merchant can be a member at the same time as being a merchant. It is the role that is being played at any one time that is important.

FIG. 1 diagrammatically illustrates the scheme business model. The online payment scheme of the present invention is organised and controlled by an administrator 101. The administrator attracts merchants 102 and members 103 to the scheme. Merchants are attracted because the scheme has the potential to increase their online sales by facilitating sales to purchasers who may not otherwise be able to make purchases online. Members are attracted to the scheme to provide benefits to purchasers 104 who elect to subscribe through one or more members 103. The benefits to a member in facilitating online purchases for subscribers may not necessarily and usually would not be monetary benefits.

In use a subscriber 104 will visit the website of a merchant 102 and place an order 105 for goods sold by that merchant. The transaction need not involve goods, the scheme would equally apply to vendors of goods or services. Merchants 102 deliver goods purchased online to subscribers 104 via conventional means or electronically if the purchased items are digital in form. Although described in more detail later, three payment transactions are involved in this scheme. Merchants 102 will notify the administrator of all purchases made. Administrator 101 will in turn notify respective members 103 of purchases made by their respective subscribers 104. Each subscriber 104 will make a payment 106 for his purchasers to the member 103 to which he subscribes. Members 103 will make a payment 107 to the administrator 101 for all purchases made by that member's subscribers. In turn administrator 101 will make payments 108 to merchants 102 for all purchases made under this scheme.

The scheme is limited to purchases of low value following the micropayments model. This reduces exposure to members and reduces the incentive for fraud.

By joining up to the scheme, each member guarantees to the administrator to pay for the purchases of its subscribers, the administrator guarantees payment to merchants who are also party to the scheme and each merchant guarantees to accept and fulfill purchase requests from members' subscribers.

Each member has its own ID, usually in the form of an ID number (although it could just be the member's name and/or include a password as well). Each subscriber also has his own ID. This usually does include a password (again it can also include an ID number or the subscriber's name). The administrator keeps a database of all the merchants, members and subscribers. It also administers the member and subscriber IDs.

Within the scheme, each subscriber has his own purchase account with a micropayment credit limit. The accounts are also maintained by the administrator in a database. The account is reset when the purchases are paid for by the member and when the member instructs the reset.

The mechanics of a typical purchase transaction will now be described.

A subscriber 104 firstly visits a merchant's website. Once the subscriber wishes to finalise his purchase he must log on and identify that he belongs to a member of the scheme, by entering his member's ID. The merchant website checks with the administrator's computer system that this is a valid ID for a member of the scheme. If it is not, the subscriber is given the chance to re-enter a valid ID (although he will have only a limited number of chances to do this). If it is a valid member ID, the subscriber enters his own ID number and password. The merchants server then checks with the administrator's computer system to see if the ID number and password match and that they match for the member whose ID was entered earlier. Additionally, the administrator's system indicates if the subscriber's scheme account credit limit has sufficient balance for the proposed purchase. If any of these checks cannot be validated, the subscriber is given an opportunity to re-enter the data (again with only a limited number of such opportunities).

If the purchase is validated by the administrator's system, then the subscriber's scheme account held in the system is updated with the purchase value, so he cannot immediately over spend his limit with another purchase. The merchant's site on receiving validation from the administrator releases an order of goods or services and if the former arranges delivery to the purchaser.

Payments subsequently flow in the manner indicated above with reference to FIG. 1.

This scheme is not necessarily any more secure than previous schemes. It is open to fraud, for example, if a third party obtains a subscriber's ID as well as the ID of the member with which the subscriber is associated. However fraud is minimised by making the scheme a type of micropayment scheme, limiting the amount any subscriber can have outstanding at any one time. For instance to US$200 or less. As soon as a subscriber makes a purchase, his account is updated. Once purchases accumulate so that a subscriber's account reaches this limit, any further purchases are prevented or, if a purchase will take a subscriber over the account's limits, then the merchant will not receive a validation from the administrator and the purchase prevented. The subscribers' accounts can only be reset by the subscriber's member making payment to the administrator. Thus fraudulent use is limited to US$200 per account.

For a purchaser to continue his fraudulent activities he must switch to other subscriber accounts. Thus he would need the IDs for many subscribers and have various different delivery addresses to avoid detection. For purchases limited in value this activity is hardly worthwhile.

The possibility of fraud can be further reduced by making delivery only to a preset address. A fraudulent user will then find it more difficult to collect his purchases without being detected.

If fraud does occur, it will usually come to light when a subscriber denies that he made a particular purchase. If this happens, the subscriber's ID is immediately suspended from the scheme and investigations made. If it is only a mistake, then the account can be reinstated. A fraudulently used subscriber ID will be invalidated not only as a subscriber of a particular member, but also from the entire scheme run by the administrator as the subscriber ID may be linked to more than one member.

Where there is deemed to be fraud, the administrator repays the member, or, where the fraud is widespread within a member, the administrator may pay the merchants directly. The administrator keeps track and analyses fraud cases and claims, seeking to determine if particular subscribers and/or members are more prone to fraud and, in some cases, even suspending or terminating the relevant subscribers and/or members from the scheme.

The above embodiment has the subscriber entering the member's ID when he wishes to make a purchase at the same time as when he enters his own ID. However, the ID entries could be made either early in the transaction or separately. The member ID could be entered as soon as the purchaser enters the merchants website and the subscriber ID entered later when the subscriber wishes to make a purchase. Further, the subscriber's ID could itself act to identify the member. An ancillary advantage of linking a subscriber with a member is that the subscriber can then be allowed access to offers only open to parties to the scheme, or even only open to the subscribers of certain members. One advantage in having a subscriber identify early his visit in the merchant's site, is that, if he has a purchasing history, he can be directed to areas of the merchant's website in which he is thought to be likely to be interested.

In the main embodiment, the only spending limits are imposed on the subscribers. The member's exposure is the total of the spending limits of all its subscribers and each member would typically be required to provide a bank guarantee for that sum. On the other hand, a member may request or be required to have a limit which is less than the sum of all its subscriber's. limits. In this case, when the total outstanding debt of a subscriber goes over that limit, none of its subscribers will be allowed to make any more purchases, no matter what the state of their own accounts.

A basic embodiment of the scheme has every subscriber with the same limit, e.g. US$200. However, it can be varied within members or from member to member, possibly according to the history of the member within the scheme or depending upon what type of body the member is. For instance, one member might want to give all subscribers a limit of only US$50 or US$500 or vary the limit between the subscribers according to seniority, performance etc. Where any limits are raised, the members may be required to take on some of the administrator's exposure to fraudulent use.

It is up to the individual members how and when they bill their subscribers for purchases. Employers may do it by deducting the amount from an employee's pay for the month (or week or other period). They may even decide not to pass the cost on to the employee but to offer this as an employee benefit. In the case of members whose whole raison d'-etre is to exist as members (rather than, for example, as employers), they may require payment up front for the whole of a subscriber's credit limit. This would be especially true for members whose subscribers are transitory and/or have no bank account or credit card. Groups such as Internet cafes could own subscriber IDs which they rent out to those wanting to use their machines. It is up to the members how they obtain payment. They may even charge for the service of providing access to the scheme.

Periodically merchants 102 will supply purchase transaction details to the administrator for payment. The administrator will pay the merchants purchase value less a small percentage.

In one embodiment, as indicated in FIG. 1, as an incentive to members to join up and to introduce merchants to the scheme, a member can be paid on the basis of the scheme transactions that are made with each merchant he has introduced. Thus for those transactions with a member introduced merchant, that member can be paid a percentage of the amount extracted by the administrator. Additionally, when the purchases are made by other members' subscribers, the introducing member may be paid a different percentage.

The scheme of the present invention has many advantages. For the subscriber, he has little or no exposure to fraudulent use. Additionally, he does not have to provide personal details over the Internet. The only fields that he needs to fill in are his identification number and a password and a delivery address if it is not to be the pre-set address. If the delivery address is not to be the pre-set address then the subscriber will have to enter another password. The merchant's website will check with the administrator's computer that the subscriber is authorised to have the purchase delivered to addresses other than the pre-set address and that the password provided by the subscriber for changing the delivery address matches the password held by the administrator's computer for delivery other than to the pre-set address. If this password does not mach the subscriber is given a chance to re-enter the data (with only a limited number of opportunities) and then given the option of having the purchase delivered to the pre-set address. Certainly there is no question of him disclosing bank details or credit card details over the Internet. Moreover, there is no need for a subscriber to have specific hardware, such as card and a card reader and no chance of losing the card.

For the members, this is a service they can provide to subscribers, therefore gaining and improving their relationships with the subscribers. Payment to the members is guaranteed, as the subscribers would be employees, members etc or because they pay upfront. It can also be a way of making money.

For the merchants, they can be sure of frequent purchases and certain payment. Payment to the merchant is guaranteed. The administrator shall guarantee payment to the merchant and the administrator, in turn, has bank guarantees from the members. As the processing costs do not involve monetary payment by the administrator, the administrator's costs are less than a credit card company's and transaction losses to the merchant are less than those when credit cards are used.

The scheme is a closed community of shoppers. A merchant will be transacting with an identifiable customer. Customer relationships can begin to exist and grow. A merchant can begin to recognise patterns from individual subscribers and members.

The administrator's database of subscribers/members and purchasing habits can provide analysable data for online shopping pattern or different demographics, social groups etc. Subject to privacy considerations this can be sold to provide additional income to the administrator.

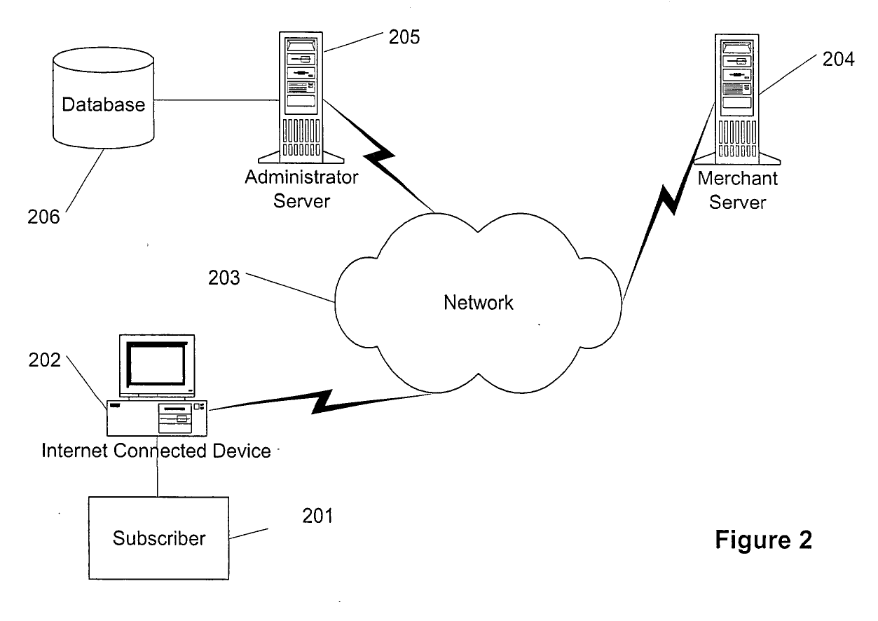

A preferred technical implementation of the transaction system will now be described with reference to FIG. 2.

The system would generally include an administrator server 205 and a plurality of merchant servers 204 connected over a network 203, such as the internet. The merchant servers 204 interact with the internet connected devices, such as personal computers, WAP enabled devices and the like, of subscribers 201 via the network 203.

The administrator server includes administrator server software which includes or interfaces with a database 206. The database 206 includes payment scheme information—member IDs, subscriber IDs, delivery addresses, change of delivery address authentication tokens, member and subscriber credit limits and member and subscriber credit balances.

The merchant servers 204 include merchant server software integrated with the electronic commerce software, which may stand-alone or be fully integrated with the merchant's online sales interface. The merchant server software provides for requesting information from subscribers, receiving request information from the subscriber's internet connected devices 202, and conversing with the administrator server 205 to validate transactions. Typically the merchant server software is configured to request and receive information over a web-based interface, thereby requiring no installed subscriber software on the internet connected device 202.

A subscriber 201 using an internet connected device 202 visits a merchants website hosted on a merchant server 204. The website lists the services and products that the merchant has for sale. Once a subscriber 201 wishes to finalise his purchase he causes the internet connected device 202 to send a member ID to the merchant server 204 via a network 203. The merchant server 204 sends the member ID to the administrators server 205 via a network 203. The administrator server 205 checks its database 206 for a match with the member ID provided by the merchant server 204. If a match is found the administrator server 205 sends a message that the member ID is valid to the merchant server 204. If no match is found in the database 206 the administrator server 205 sends an invalid member ID validation message to the merchant server 204 via a network 203. If the member ID is invalid the merchant server 204 request the subscriber 201 to re-provide the member ID and the process of checking for a valid ID begins again. Only a limited number of opportunity to provide a valid member ID will be allowed. If the member ID is valid the merchants server 204 requests the subscriber 201 to provide a subscriber ID and password.

The subscriber 201 then provides their subscriber ID and password via the internet connector device 202, the Internet connected device 202 forwards the subscriber ID and password to the merchant server 204 via a network 203. The merchant server 204 forwards the subscriber ID and password to the administrator's service 205 via a network 203. The administrator server 205 checks for a match in database 206 of the subscriber ID and password. If there is a valid subscriber ID and password he administrator server 205 sends an ID and password confirmation message to the merchant's server 204 via a network 203. The administrator server 205 checks the database 206 to see if the subscriber scheme account credit limit and the member scheme account credit limit has sufficient balance for the proposed purchase. If there is sufficient balance the administrator server 205 sends a sufficient balance confirmation message to the merchant server 204 via a network 203. If there is insufficient balance the administrator server 205 sends an insufficient balance message to the merchant server 204. The administrator server 205 also recalls the delivery address from its database based on the member ID and subscriber ID. The administrator server 205 sends the delivery address to the vendor server 204 via a network 203. If any of these checks cannot be validated the subscriber 201 is given an opportunity to re-provide their data.

Upon validation by the administrator server 205 the subscriber system account held in the database 206 is updated with the purchase value so that the subscriber 201 cannot immediately overspend their limit with another purchase. When the merchant server 204 receives a validation message from the administrator server 205 it releases the order of goods and services and if appropriate arranges delivery to the purchaser.

In the situation where the subscriber 201 wishes the purchase to be delivered to an address other than the pre-set address held in the administrator database 206, then the subscriber 201 provides a delivery address change authentication token to the merchant server 204 via their internet connected device 202. The internet connected device 202 forwards the token to the merchant's server 204 via a network 203. The merchant server 204 forwards the change of address validation token to the administrator server 205 via a network 203. The administrator server 205 checks if the address change validation token provided matches the address change validation token held in its database 206 for the subscriber ID. If there is a match then the administrator server 205 sends a delivery address change validation message to the merchant server 204 via a network 203. If there is no match the administrator server 205 sends a change of address delivery failure message to the merchant server 204 via a network 203. If there is still an invalid match after the member has been given a number of chances to re-provide the change of address authentication token the subscriber 201 will be given the opportunity of having the goods delivered to the pre-set address.

The invention has been described with reference to the Internet. However, it is not limited to such use, but could be operated over other networks, such as an extranet.

The scheme of the present invention provides new opportunities for all four parties involved. Subscribers will include persons who may not be able to obtain credit cards. Merchants online sales may increase with the addition of a new group of purchases. The position of member provides new business opportunities, especially for entities who be established solely for this purpose.

Various embodiments and possibilities have been described. Other alterations and variations are also possible without departing from the invention as described herein and/or as claimed.

1. A payment scheme for online purchases which includes as participants vendors, a scheme administrator, member organisations and purchasers, characterised in that:
participating purchasers are subscribers to a member organisation,
vendors charge the scheme administrator for the value of all purchases made by subscribing purchasers,
the scheme administrator charges the member organisations to which purchasers subscribe for their purchases,
and member organisations have in place their own arrangements with their subscribing purchasers to recover money or moneys worth in exchange for the payments they make on behalf of subscribers to the scheme administrator.

2. A payment scheme for online purchases according to claim 1 wherein said scheme administrator maintains a database of subscribing purchasers and the members to whom each subscriber belongs, wherein each subscriber has a scheme identifier (ID) which is held by the administrator and which must be provided to vendors when making a purchase and wherein during each online purchase transaction the vendor forwards the subscriber ID to the administrator for validation and allows the purchase transaction to be concluded only if validation is received back from the administrator.

3. A payment scheme for online purchases according to claim 2 wherein a limit is set on the value of purchases a purchaser may make, wherein during each online purchase transaction the vendor additionally forwards the transaction value to the administrator,
the administrator checks that the total of the unpaid transactions in the account of that subscriber (including the present transaction) does not exceed said limit and if not provides the vendor with a further transaction validation allowing the purchase transaction to be concluded.

4. A payment scheme for online purchases according to either claim 2 or 3 wherein the delivery address for the purchases of a purchaser is preset and during each online purchase transaction where the purchaser desires the delivery address to be other than the pre-set delivery address, the purchaser provides to the vendor an authentication token, and the vendor forwards the authentication token to the administrator for validation and the vendor will dispatch the purchase to other than said pre-set delivery address only if validation is received back from the administrator.

5. A payment system for online purchases which includes as participants vendors, a scheme administrator, member organisations and purchasers, comprising:
vendor web servers, each capable of accepting online purchase orders,
internet devices to which participating purchasers have access, said purchasers being subscribers to a member organisation,
an administrator server connected online which holds a database of members and their subscribers,
said vendors web servers being programmed to transmit purchase charge data to said administrator server after accepted purchase orders are made by a participating purchaser,
said administrator server being programmed to periodically send purchase charge data to member organisations in respect of purchasers who are subscribers of those members,
and means enabling said members to remit payment for said purchases to said administrator.

6. A payment system for online purchases according to claim 5 wherein each subscribing purchaser has a scheme identifier (ID), said administrator database stores purchaser IDs, said vendors web server being programmed to interrogate said administrator database in real time during a purchase transaction initiated by a purchaser, said administrator server is programmed to check its database for a match between the purchaser entered ID and the database and respond to said vendor server with a purchase validation message if a match is found, or respond with a purchase denied message if no match is found.

7. A payment system for online purchases according to claim 6 wherein said administrator server is programmed to accumulate the value of each purchase made by a purchaser held in the database and store the same in a purchaser account, a predetermined purchase value limit is stored for each purchaser, and wherein the administrator server is programmed to check the database to verify that the total of unpaid transactions in the account of that subscriber (including the current transaction) does not exceed said limit, and if not to transmit to the vendor's server a validation message enabling the purchase transaction to be concluded, and if said limit is exceeded to transmit to the vendor server a purchase denied message.

8. A payment system for online purchasers according to claims 6 and 7 wherein for at least one subscribing purchaser said administrator database stores a preset delivery address and a change of delivery address authentication token, said vendor's web server is programmed to receive a purported change of delivery address authentication token, interrogate said administrator server, and said administrator server is programmed to check its database for a match between said purported change of delivery address authentication token and the token in said database and respond to said vendor server with a change of delivery address validation message if a match is found or respond with a change of delivery address denied message of no match found.
